(19) United States
(12) Patent Application Publication
(10) Pub. No.: US 2012/0094698 A1
(43) Pub. Date: Apr. 19, 2012

(54) Location aware message restriction and auto-replay feature

(76) Inventor: Paul Casto, Bowie, MD (US)

(21) Appl. No.: 13/067,765

(22) Filed: Jun. 24, 2011

Related U.S. Application Data
(60) Provisional application No. 61/344,296, filed on Jun. 24, 2010.
(60) Provisional application No. 61/344,295, filed on Jun. 24, 2010.

(51) Int. Cl. H04W 4/02

(52) U.S. Cl. 455/456.4

(57) ABSTRACT

A system and method of delaying delivery of a content message to a mobile device is provided. A control message, associated with a mobile device, based on location information associated with the mobile device is received. A content message for the mobile device is received. Delivery of the content message to the mobile device is delayed based on the control message.

This application claims priority from U.S. Provisional No. 61/334,295, entitled “MESSAGE AUTO-REPLY AND MESSAGE HOLD FOR SHORT MESSAGING SYSTEM”, and U.S. Provisional No. 61/334,296, entitled “ENHANCED LOCATION BASED CALL RELATED INFORMATION (CALLER ID)”, both filed Jun. 24, 2010, the entireties of both of which are expressly incorporated herein by reference.

### BACKGROUND OF THE INVENTION

1. Field of the Invention

This invention relates generally to telecommunications, Voice Over Internet Protocol (VOIP), cellular communications, and location based systems. More particularly, it relates to short message services (SMS), email to mobile devices, and video to mobile devices.

2. Background of the Related Art

Modern electronic devices, such as smart-phones, tablet computers, laptop computers, vehicle information centers, etc., are extremely mobile. This mobility lends to their use at times where such use is inappropriate. For example, for a distracted driver or a distracted student receiving and transmitting electronic content, e.g., SMS/Email, Video, pictures, etc., on a mobile device is performed at certain times when such use is prohibited, unsafe, or oftentimes both prohibited and unsafe.

Conventionally, there is no way to hold electronic content from being displayed for a user during inappropriate use. There are times when it would be appropriate to hold messages or other deliveries, and not deliver them to a subscriber until conditions that make such delivery inappropriate have changed or subsided.

Recipients of SMS messages sometimes need to alert senders to their status, and potential inability to respond to messages. This response may be needed when the handset is in coverage, out of coverage, or off (an ‘out-of-office’ type reply for example). Additionally recipients of SMS messages may want messages centrally held, and not delivered to their handset, to reduce distractions while driving, or at any other time when distractions might occur, such as a meeting, or in school.

There are ‘smart-phone’ based applications which provide an automated reply once a message is received, but this approach is limited to certain classes of phone, and only works when the phone is turned on, and in coverage.

There may be existing SMSC systems, which allow for auto-reply functionality, without the ‘hold’ aspect described here, but from initial research, it appears that there are not systems which provide the flexibility and ease of subscriber use, which is provided through the key-word approach described below.

The ‘auto-reply based on smart-phone application’ approach is limited to certain classes of phone, and only works when the phone is turned on, and in coverage. Additionally, that approach does not solve the need to centrally hold the messages, to eliminate distractions which may be caused by the initial message receipt.

The ‘auto-reply at the SMSC’ (if implemented), may allow subscribers to configure their own auto-reply message, but unless there is a comparable approach of using key-words to activate various canned messages, this puts the burden on the subscriber to enter a large amount of text, which will limit the usefulness in many cases.

### SUMMARY OF THE INVENTION

In accordance with the principles of the present invention, a method of delaying delivery of a content message to a mobile device is provided. The method, according to the principles of the present invention, receives a control message, associated with a mobile device, based on location information associated with the mobile device. A content message for the mobile device is received. Delivery of the content message to the mobile device is delayed based on the control message.

In addition, in accordance with the principles of the present invention, a mobile device for delaying delivery of a content message is provided. A receiver receives a control message based on location information associated with the mobile device and a content message for the mobile device. A delay module delays delivery of the content message on the mobile device based on the control message.

Additionally, in accordance with the principles of the present invention, a supporting infrastructure server for delaying delivery of a content message is provided. A receiver receives a control message based on location information associated with a mobile device and a content message for the mobile device. A delay module delays delivery of the content message to the mobile device based on the control message.

### BRIEF DESCRIPTION OF THE DRAWINGS

Features and advantages of the present invention will become apparent to those skilled in the art from the following description with reference to the drawings, in which:

FIG. 1 illustrates a system for implementing hold restrictions, in accordance with the principles of the present invention.

FIG. 2 illustrates a method for implementing hold restrictions, in accordance with the principles of the present invention.

FIG. 3 illustrates a method for implementing ‘auto-reply’, in accordance with the principles of the present invention.

### DETAILED DESCRIPTION OF ILLUSTRATIVE EMBODIMENTS

A manual opt-in process requires the subscriber to send an SMS message to initiate and clear a ‘hold.’ However, such a manual/opt-in approach takes extra time to initiate when the subscriber is starting to drive, or entering a school. Also, there is the chance that the subscriber might forget to turn the ‘hold’ off at the time the activity or location changes, so that messages will be unnecessarily delayed. Moreover, the subscriber may not be the one choosing the ‘hold’ behavior, such as the user's parents, or when in a school setting enforcing a “no texting in school” policy, in which cases ‘opt-in’ is not an appropriate solution.

Using a location-aware application on the mobile-device, a control message is sent to set or clear the subscriber's hold status, based on location boundary conditions (e.g., entering a pre-defined school zone), or based on velocity (e.g., linear motion over 10 mph assumed to indicate that the mobile user is driving).

Ideally, the present invention is tailored to the particular use-case. Preferably, the invention implements provisions for ‘opting out’ of the hold conditions, to handle cases such as when although a linear speed of the user might otherwise indicate that they are driving, they are in fact merely a passenger in a car being driven by someone else.

Additionally, the behavior can be triggered using server based location based services to detect position and velocity, rather than a location aware application executed on a mobile-device. In this case, a sub-set of the subscriber opt-out capability may be made available to the user.

The invention is generally applicable to many forms of deliveries to mobile-devices, such as SMS, Email, video, pictures, etc., with appropriate differences in their implementations. The term ‘content messages’ as used throughout this application is intended to cover each of these different types of delivery.

The inventive embodiments may take one of several forms, supporting different use cases. Three named cases or embodiments are provided to provide substantive examples for the descriptions which follow: (1) Distracted-Driver (Permissive); (2) Distracted-Driver (Alerting); and (3) Distracted-Driver (Restrictive).

Distracted-Driver (Permissive)—this covers a case where an older (non-teen) driver wants the convenience of putting messages on-hold, but also to be able to take the system off of hold (temporarily opt-out), while travelling as a passenger, or on public transportation. In this case, the ‘opt-out’ to take messages off of hold works on ‘the honor system’—the subscriber makes a choice.

Distracted-Driver (Alerting)—this covers a case where a younger driver has rules imposes by parents, which require putting messages on hold, but is able to take the system off of hold, while travelling as a passenger, or on public transportation, but when doing so the action sends an alert (such as an SMS message) to a designated device (e.g. a parents phone). In this case, the ‘opt-out’ to take messages off hold works with the model ‘trust but verify.’ The subscriber makes a choice, but is aware that the parents may review that choice.

Distracted-Driver (Restrictive)—this covers a case where a younger driver has rules imposes by parents, which require putting messages on hold, but is able to take the system off of hold, while travelling as a passenger, or on public transportation, but when doing so the action sends a request message (such as an SMS message) to a designated control device (e.g. a parents phone), which then needs to authorize the change. In this case, the ‘opt-out’ to take messages off hold works with the model ‘strict control.’ The subscriber makes a request, but the parents make the choice.

Additionally, for example, the latter two cases may also be applied to ‘Distracted-Student’, whereby the restrictions are imposed based on location/area (also known as geo-fencing), rather than velocity. Other similar extensions could be applied to the rules, but for the purpose of describing the invention, and its application, the three named-examples above suffice.

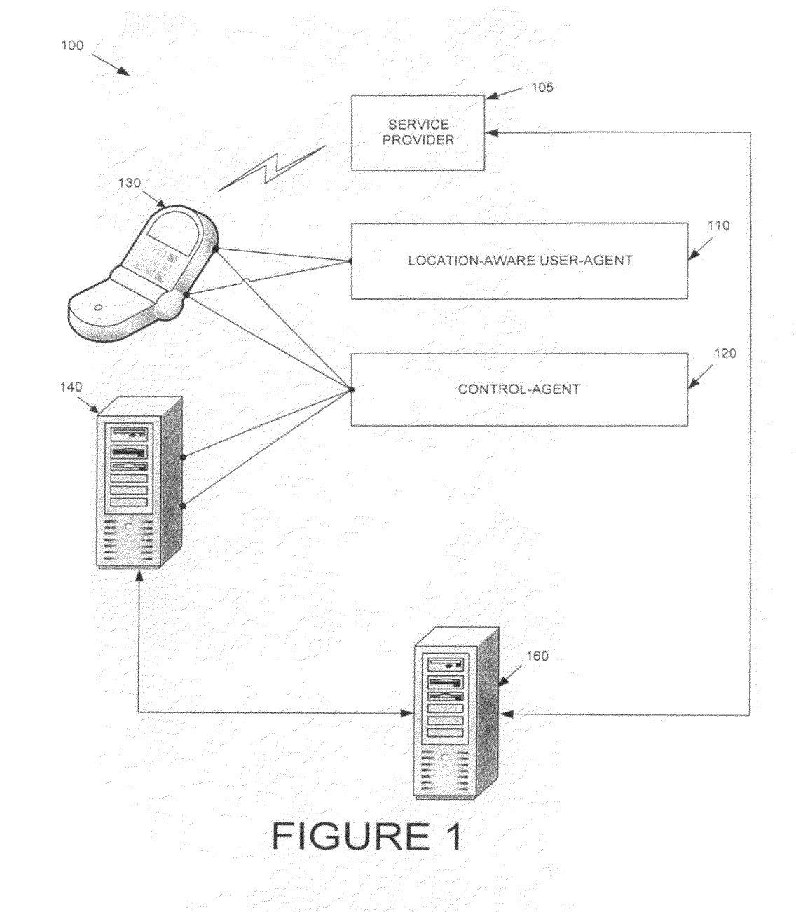

FIG. 1 illustrates a system 100 for implementing hold restrictions, in accordance with the principles of the present invention.

In accordance with the principles of the invention disclosed herein, each of the three described embodiments are solved through a combination of a location-aware user-agent 110, a control agent 120, and supporting infrastructure server 160. One or more data communication networks, either hardwired or wireless (not shown for simplicity) allow the various components of the embodiments disclosed herein to communicate with one another, as is known within the art.

The location-aware user-agent 110 may be either an application (or component of an application) running on a smart-phone 130, or may be a network-based location server 130 that tracks and reports location information for the smart-phone 130. The former approach reduces the network-load, as some of the intelligence and ‘location-awareness’ has been shifted to the smart-phone 130. The later approach increases network load, as the smart-phone 130 must be tracked from another system, i.e., the network-based location server 130, but allows smart-phones 120 which are unable to run mobile-device based applications to take advantage of the service disclosed herein.

The control agent 120 may also be either an application (or component of an application) running on a smart-phone 130, or may be a network-based server 140, that sends appropriate control messages based on mobile location obtained from the network-based location server 130 and established rules. The same advantages and disadvantages listed for the location-aware user-agent 110 apply to the control agent 120.

There are additional considerations for the control agent 120. The network-based control agent 120 may have advantages in situations where the ‘hold’ rules may need to be changed or enforced by someone other than the subscriber of the smart-phone 130 (e.g. Distracted-Driver (Restrictive)), whereas an application based control agent 120 might be the simplest approach for a case such as Distracted-Driver (Permissive). An application based control agent 120 prevents a content message from being displayed for a user, thus prevent distraction, in accordance with the principles disclosed herein.

The supporting infrastructure server 160 is a network based element which has the ability to hold messages, based on appropriate messages from the control agent 120. For most systems which use a store and forward delivery mechanism (SMS, Email, Video/Pictures), this is a straight-forward extension of the current functionality. It must be coupled to the control agent 120 with an appropriate message interface. Supporting infrastructure server 160 can include an email server, an SMS server, an IM server, a chat server, etc.

A simple implementation of this invention may be used in support of a Distracted-Driver (Permissive) with the following:

An application, running on the smart-phone 130 with ‘hooks’ into the mobile device's operating system and other subsystems. The application has the ability to send and receive formatted short-messages, for system control, and periodically determine location and velocity information.

The application (control agent 120), provides a user with configuration basic options (e.g. triggering velocity, how long after stopping to deliver messages), and/or more advance options, such as time-of-day to consider as possible travel/no-travel times (e.g. for a person who drives to the train each day).

The application (control agent 120) also provides the user with configurations options based on the services/message systems to be controlled.

Upon detection of velocity that exceeds a pre-defined trigger level (location-aware user agent 110), and verification against other rules (control agent 120), the application sends a content message or messages to the supporting infrastructure server 160. This message may take the form of an SMS, for example sending the keyword ‘CAR’ to an appropriate short code for HOLD (4653), which would then place all SMS's on hold. The content message may also take the form of an Email-service command to indicate that the mobile-device's Email client is to be put in a disconnected mode. The content message may also take the form of a ‘Be Right Back’ or ‘Offline’ type message to instant messaging (IM) sessions, or similar interactive connections.

A permissive aspect of the present invention comes into play when the subscriber of the smart-phone 130 chooses to override the ‘hold’ messages of the various types mentioned above. The subscriber does this by choosing an option from the application to indicate that they are not a driver, but instead are merely just a passenger with someone else driving.

Depending on the relevant carrier's desires, and various laws, the latter choice may be implemented using a simple key-press combination (the very permissive approach), or may require an acknowledgement ‘splash-screen’, to remind the subscriber of their obligations to comply with local laws.

Since this case is ‘permissive’, the content messages from the control agent 120 to the supporting infrastructure server 160 may or may not set limits on the subscriber's ability to originate messages. Either case is possible, at the carrier's discretion. If a carrier wished to block originating messages (except to control or emergency numbers), then a driver who wishes to send messages even though they are driving may be required to click past an acknowledgement of liability prior to doing so.

A more complex implementation of this invention may be used in support of the Distracted-Driver (Restrictive)/Distracted-Student (Restrictive):

An application, running on a web accessible server, e.g., control server 140, provides a secure environment where parents can set rules for devices on their account, as configured by the carrier.

The application (control agent 120), provides the user with configuration basic options (e.g. triggering velocity, how long after stopping to deliver messages), or more advance options like time-of-day to consider as possible travel/no-travel times (e.g. for a person who drives to the train each day).

The application (control agent 120) also provides the user with configurations options based on the services/message systems to be controlled.

That application (control agent 120) receives messages from a location-aware user-agent 110 (in this example network based), which provides periodic data on the location and velocity of the smart-phone 130.

The control server 140 checks messages received from the network-based location server 130, and compares the criteria against the rules. Upon detection of a condition which triggers a ‘hold’ or ‘release’ rule, the application (control agent 120) sends a content message or messages to the supporting infrastructure server 160.

As this is a server-based control agent 120, rather than a smart-phone based control agent 120, the control message is generally a TCP/IP based message, such as an SMPP or SMPPp message to an SMSC to change a particular subscriber's status. The content message may also take the form of a Mail-service command to a mail server (not shown) to indicate that the smart-phone's 130 email client is to be put in a disconnected mode.

The restrictive aspect of this invention comes into play when the subscriber requests to override the ‘hold’ messages of the various types mentioned above. The subscriber does this by sending a content message (such as a request for override to a short-code). The application/control-agent 120 then forwards that message on to a parent designated device, who then log into the control server 140 to grant the over-ride.

The methods of accessing the control server 140 accommodate various secure means, based on the nature of the access. Access to establish rules are generally performed via a rich web interface. However, access to override rules may be done via SMS, or even through an Interactive Voice Response system. The latter approaches facilitate parental control/choice when they do not have web access.

Since this case is ‘restrictive’, the content messages from the control-agent 120 to the supporting infrastructure server 160 may also impose limits on the subscriber's ability to originate messages. For example, if messages are on-hold going to the subscriber, the subscriber may also be blocked from originating messages except to the control agent 120 code, the parent, or designated emergency numbers.

In accordance with another embodiment of the invention, supporting infrastructure server 160, e.g., a Short Message Service Center (SMSC), will to allow subscribers of the smart-phone 130 to enable the supporting infrastructure server 160, e.g., SMSC, to take ‘auto-reply’ and ‘hold’ action, as discussed above, on their behalf. The subscribers of the smart-phone 130 can control this extra functionality through the use of SMS to Carrier designated short codes, and through the use of Carrier designated key words. This allows a user to quickly and easily set their state and standard message (e.g. by sending the word ‘car’ to the short-code for HOLD (4653), and then when they are off-hold to send another word ‘off, to the same short code to disable the auto-reply and hold feature.

The content message to be held would optimally be held within the supporting infrastructure server 160, e.g., the SMSC server (or server farm), but could be held in an off-board storage system for capacity reasons. Additionally this status/state may be managed by other servers, or user-agents acting on behalf of the subscriber.

The Auto Reply Feature disclosed herein enables subscribers of the smart-phone 130 to automatically return an informative short message to the originator device of messages they receive. The feature provides options to allow subscribers to place messages on hold, as discussed above, during the Auto Reply period and/or to use canned or personalized messages.

The service provider 105 can provision a set of keywords and canned messages associated with the keywords. Alternatively, with appropriate service classification or subscriber record settings, a subscriber of the smart-phone 130 can create a personalized reply. The subscriber using the features disclosed herein can activate (with or without a corresponding “hold” of incoming messages) and deactivate the Auto Reply Feature from their handset.

When the feature is activated without the Hold option, the subscriber's Auto Reply message is sent to the originator device and a delivery attempt will be made to the Auto Reply subscriber. Messages in a message queue at supporting infrastructure server 160, if there is one, are processes as they are for any subscribers without the Auto Reply turned on.

When the Auto Reply Feature is activated with the Hold option, a delivery attempt will not be made for the received short message. Instead, all of the subscriber's incoming messages will be sent to the message queue at supporting infrastructure server 160 for storage. An exception can be made for voice mail messages and responses to administrative Auto Reply messages which have delivery attempts regardless of the Auto Reply Feature status.

The ‘hold’ option may be removed by either turning “OFF” the Auto Reply Feature or removing the ‘hold’, but keeping the Auto Reply Feature activated (sending “ON” to the short code with “Hold_Messages” flag turned off in the Auto_Reply form). When the ‘hold’ is removed, the queued messages will have delivery attempts initiated.

From the service provider 105 perspective, the Auto Reply feature disclosed herein must be provisioned in the COS to control whether or not the system will handle it on a per class of service level.

Systems supporting Auto Reply must have an Auto_Reply table provisioned. Short_Code, Hold_Messages, and Allowed_Keywords fields form the framework of the ‘hold’ feature disclosed herein. The system 100 is designed to allow the Auto_Reply form to be to be provisioned in nearly duplicate pairs:
Short Code record 1 would have Hold_Messages provisioned false allowing subscribers to activate only the auto reply; and
Short Code record 2 would have Hold_Messages provisioned true allowing subscribers to activate the auto reply and place delivery of their messages on hold.

The Allowed_Keywords fields hold lists of keywords or “abbreviations” corresponding to the provisioned canned messages stored in the Auto_Reply_Canned_Text form. When the subscriber of the smart-phone 130 activates the Auto Reply feature disclosed herein, his choice of message keyword is stored in a subscriber's database record. Subsequent activation/deactivation of the Auto Reply does not modify his initial choice, unless the subscriber of the smart-phone 130 enters a new keyword. Preferably a keyword of “my” indicates that the particular subscriber has a personalized message. The personalized message is also stored in the database.

Allowed Keyword provisioning preferably has the following restrictions:
The maximum length of a key word is 10 characters.
The words are separated by commas. Note that the application adds commas as separators at the end of each Allowed_Keywords 1 . . . 4 field, so no trailing comma need be entered.
A keyword must fit in a single “Allowed_Keywords1 . . . 4” field. It must not be divided between fields, otherwise each portion of the word will be treated separately.
The Allowed Keyword must not be a reserved word: “my”, “on”, “off”, “list”, or “status”.

The Auto_Reply_Canned_Text form can also be provisioned with the Allowed_Keyword and corresponding message text.

The Auto Reply feature disclosed herein for a subscriber's account can be defined on a class of service level or on the subscriber level (with the subscriber level taking precedence). On the subscriber level, there is also a value of “not_allowed” which the service provider 105 support staff can set when the subscriber's COS allows the feature but this specific subscriber does not want the feature on their smart-phone 130. Alternatively, support staff of the service provider 105 could just assign that particular subscriber to a different COS that does not have the disclosed Auto Reply Feature.

The provisioning of the subscriber level Auto Reply capabilities can be done by the service provider 105 utilizing USLI commands NEW and CHG via SMPPp or ISIS interface. These commands modify feature control data in the subscriber database.

The Auto Reply feature disclosed herein allows the subscriber of the smart-phone 130 to send text messages to a specific short code to perform the following types of Auto Reply actions:
1. Turn the feature is on or off.
2. Control whether messages are placed on Hold or delivered normally.
3. Select message text to be sent as Auto Reply—either canned of his choice or personalized.
4. View the status of his account
5. List existing keywords and associated text he could utilize.

For the Personal Auto Reply feature disclosed herein, the Auto Reply subscriber of the smart-phone 130 specifies the text of the Auto Reply text message sent to the originator. This text is stored in the subscriber's database. Once the text is stored in the subscriber's database, the subscriber of the smart-phone 130 can activate and deactivate without specifying the text again. A Personal Auto Reply feature can allow the subscriber of the smart-phone 130 to use canned messages as their Auto Reply Text.

The Auto Reply subscriber handset commands are similar to the USLI commands in name, however the output and format preferably differ. The text functionality/commands are as follows:
Turn service ON—send one of the following commands to turn the Auto Reply on with the corresponding text:
“ON”—sending “ON” uses last activated Auto Reply response. If there is not a keyword already associated with the subscriber account, the defaults keyword will be used (the first provisioned keyword is the defaults)
<keyword>—for example—“CAR”—sending a keyword turns the Auto Reply on using the canned text associated with the keyword
“MY”—turn on feature using previously specified personalized text
<personalized_text>—for example—“OUT SHOPPING NOW”—sending a string of personal text turns the Auto Reply on using the string as the response. This is only available if the feature is allowed in the class of service.
“OFF”—sending the single command “OFF” turns off the Auto Reply and, if the messages were on HOLD for the Auto Reply, starts delivery attempts.

LIST keywords and/or text—sending one of the following words or combinations causes a short message to be returned with the indicated contents.
“LIST”—returns a list of all available keywords
“LIST <keyword>”—returns canned text for the specified keyword
“LIST MY”—returns current status (“ON” or “OFF”) plus personal text
“STATUS”—sending the single command “STATUS” returns subscriber's status “OFF”, “ON”, or “HOLD” and one of the following indications of the Auto Reply:
the text of the default keyword if no keyword is specified
text of the personal message
text of the personal message and text associated with a currently used canned keyword if the personal message is not being used.

While this implementation disclosed herein does not restrict subscribers of the smart-phone 130 from originating SMSs while in a hold state, there are natural extensions which can be implemented to add that functionality.

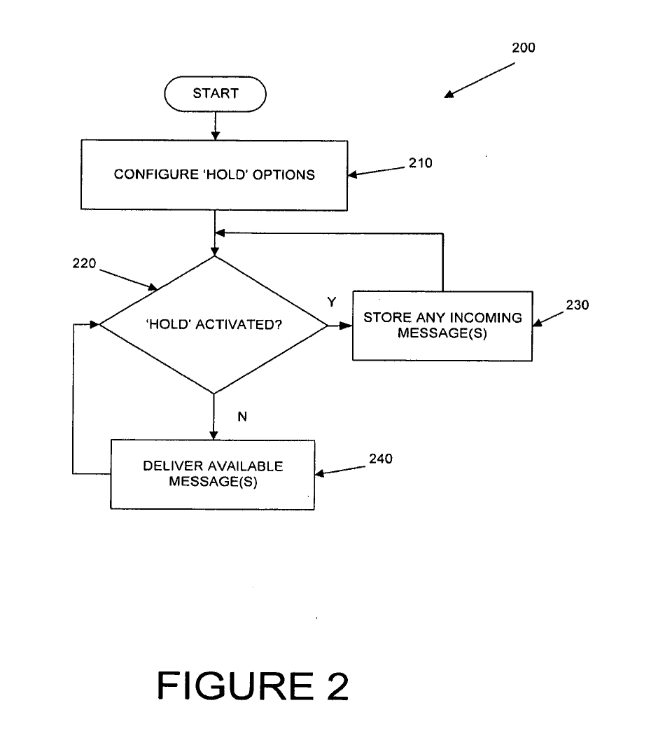

FIG. 2 illustrates a method for implementing hold restrictions, in accordance with the principles of the present invention.

The method for implementing hold restrictions 200 begins with a step for configuration of hold options 210. As discussed above, control agent 120 can provide a user with configuration basic options (e.g. triggering velocity, how long after stopping to deliver messages), and/or more advance options, such as time-of-day to consider as possible travel/no-travel times (e.g. for a person who drives to the train each day). A control agent 120 can provide the user with configurations options based on the services/message systems to be controlled. Configuration options can include activation and de-activation of the ‘hold’ features disclosed herein.

A determination is made as to the status of ‘hold’ restrictions in step 220. In step 230 the control server 140 checks messages received from the network-based location server 130, and compares the criteria against the rules associated with the ‘hold’ features disclosed herein.

Upon detection of a condition which triggers a ‘hold’ or ‘release’ rule, the application (control agent 120) sends a content message or messages to the supporting infrastructure server 160. If a ‘hold’ rule is active, step 220 branches to step 230 triggering storage of any pending SMS's in a queue for future delivery. If a ‘release’ rule is active, step 220 branches to step 240 triggering delivery of any SMS's that are stored in the queue addressed to the smart-phone 130.

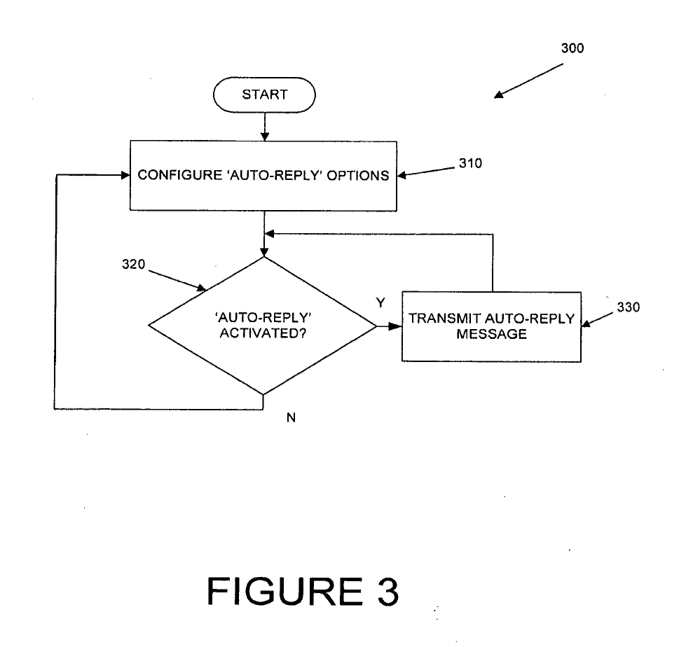

FIG. 3 illustrates a method for implementing ‘auto-reply’, in accordance with the principles of the present invention.

The method for implementing auto-reply 300 begins with a step for configuration of auto-reply options 310. As discussed above, service provider 105 can provide a user of the smart-phone 130 with configuration basic options that can include the ability to transmit a canned message or a custom message back to a message initiating device, as discussed above. The service provider 105 can provide the user of the smart-phone 130 with configurations options based on the services/message systems to be controlled. Configuration options can include activation and de-activation of the ‘auto-reply’ features disclosed herein.

A determination is made as to the status of ‘auto-reply’ in step 320. In step 330 the control server 140 checks messages received from the network-based location server 130, and compares the criteria against the rules associated with the auto-reply features disclosed herein.

Upon detection of a condition which triggers an ‘auto-reply’ rule, the application (control agent 120) sends a content message or messages to the supporting infrastructure server 160. If an ‘auto-reply’ rule is active, step 320 branches to step 330 triggering delivery of any auto-reply SMS's that are configured to be transmitted in response to a received SMS addressed to the smart-phone 130.

The embodiments disclosed herein provide for novel ‘hold’ restrictions and ‘auto-reply’ features for any type of content message delivery to the smart-phone 130. The content message may also take the form of an Email-service command to indicate that the mobile-device's Email client is to be put in a disconnected mode. The content message may also take the form of a ‘Be Right Back’ or ‘Offline’ type message to instant messaging (IM) sessions, or similar interactive connections. Other distracting messages that can be placed on ‘hold’ and result in an ‘auto-reply’ message can include Twitter messages, Really Simple Syndication (RSS) messages, chat room messages, etc.

The present invention has applicability in markets including wireless carriers wishing to assist a subscriber with complying with applicable distracted driving laws. It also has applicability for use by parents of minors and others wishing to place limits on their children's use of text messaging while they are driving or at school.

The present invention has applicability to wireless carriers' offering ‘distracted driver’ products for SMS, including use of a ‘hold’ function and auto-reply feature. It also has applicability to wireless carriers' offerings of enhanced out-of-office products and services for SMS, including use of a keyword-based out of office command structure.

While the invention has been described with reference to the exemplary embodiments thereof, those skilled in the art will be able to make various modifications to the described embodiments of the invention without departing from the true spirit and scope of the invention.

1. A method of delaying delivery of a content message to
a mobile device, comprising:
receiving a control message, associated with a mobile device, based on location information associated with said mobile device;
receiving a content message for said mobile device; and
delaying delivery of said content message to said mobile device based on said control message.

2. The method of delaying delivery of a content message to a mobile device according to claim 1, wherein:
said mobile device is a smart-phone.

3. The method of delaying delivery of a content message to a mobile device according to claim 1, wherein:
said content message is a short message service (SMS) message.

4. The method of delaying delivery of a content message to a mobile device according to claim 1, wherein:
said receiving said control message is performed by said mobile device.

5. The method of delaying delivery of a content message to a mobile device according to claim 1, wherein:
said receiving said control message is performed by a control server.

6. The method of delaying delivery of a content message to a mobile device according to claim 1, wherein:
said delaying delivery delays transmission of said content message to said mobile device.

7. The method of delaying delivery of a content message to a mobile device according to claim 1, wherein:
said delaying delivery delays display of said content message on said mobile device.

8. The method of delaying delivery of a content message to a mobile device according to claim 1, wherein:
said method of delaying delivery of said content message to said mobile device is implemented on said mobile device.

9. The method of delaying delivery of a content message to a mobile device according to claim 1, wherein:
said method of delaying delivery of said content message to said mobile device is implemented on at least one server remote from said mobile device.

9. (canceled)

10. The method of delaying delivery of a content message to a mobile device according to claim 1, wherein:
said location information is produced by said mobile device.

11. A mobile device for delaying delivery of a content message, comprising:
a receiver to receiving a control message based on location information associated with said mobile device and a content message for said mobile device; and
a delay module to delay delivery of said content message on said mobile device based on said control message.

12. The mobile device for delaying delivery of a content message according to claim 11, wherein:
said mobile device is a smart-phone.

13. The mobile device for delaying delivery of a content message according to claim 11, wherein:
said content message is a short message service (SMS) message.

14. The mobile device for delaying delivery of a content message according to claim 11, wherein:
said control message is received from a control server.

15. The mobile device for delaying delivery of a content message according to claim 11, wherein:
said location information is received from a location-aware user-agent remote from said mobile device.

16. The mobile device for delaying delivery of a content message according to claim 11, wherein:
said location information is produced by said mobile device.

17. A supporting infrastructure server for delaying delivery of a content message, comprising:
a receiver to receiving a control message based on location information associated with a mobile device and a content message for said mobile device; and
a delay module to delay delivery of said content message to said mobile device based on said control message.

18. The supporting infrastructure server for delaying delivery of a content message according to claim 17, wherein:
said mobile device is a smart-phone.

19. The supporting infrastructure server for delaying delivery of a content message according to claim 17, wherein:
said content message is a short message service (SMS) message.

20. The supporting infrastructure server for delaying delivery of a content message according to claim 17, wherein:
said control message is received from a control server.

21. The supporting infrastructure server for delaying delivery of a content message according to claim 17, wherein:
said location information is received from a location-aware user-agent remote from said mobile device.

22. The supporting infrastructure server for delaying delivery of a content message according to claim 17, wherein:
said location information is produced by said mobile device.
